(19) United States
(12) Patent Application Publication
(10) Pub. No.: US 2006/0075250 A1
(43) Pub. Date: Apr. 6, 2006

(54) Touch panel lock and unlock function and hand-held device

(76) Inventor: Chung-Wen Liao, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/950,088

(22) Filed: Sep. 24, 2004

(51) Int. Cl. H04L 9/00

(52) U.S. Cl. 713/182

(57) ABSTRACT

A lock and unlock function triggered by a touch panel of a hand-held device. The hand-held device detects a pattern input from the touch panel, and execute the lock/unlock function to enable or disable the keypad and the touch panel once the input pattern matches the specified pattern using a pattern recognition algorithm.

### BACKGROUND

The invention relates to lock and unlock function in a hand-held device, and more specifically, to a lock and unlock mechanism triggered by a specific input from a touch panel.

A hand-held device such as a personal digital assistant (PDA), mobile phone, or any portable radio device, necessarily comprises a user-interface for operating the device. The user-interface may include a keypad having a plurality of buttons or keys, and a touch panel. The hand-held device may be placed in locations where objects may interfere with the user-interface mechanism, or indeed the user may inadvertently press or touch one or more keys on the keypad or the touch panel, thereby activating the device. Inadvertent actuation of the keys may, for example, turn the device on or off, cause transmission of unwanted signals and prevent use of a radio channel, or cause undesired functions to occur.

U.S. Pat. No. 5,241,583 discloses a portable radio telephone comprising a keypad, means for sensing the actuation in a unique predetermined order of a first and second key respectively, and means responsive to the sensing means for disabling all keys of the keypad except the two keys associated with the locking facility. The keypad lock is toggled on or off whenever the two keys, such as the # key and the ON/OFF key, are actuated in a unique predetermined order. Instead of sequential keystrokes, the keypad lock may also be enabled if the two keys are actuated simultaneously or if the second key is actuated while the first key is depressed.

Another popular hand-held device keypad lock and unlock mechanism is triggered by pressing a specific key for longer than a predetermined period of time, for example, pressing the star key (*) for more than 3 seconds.

### SUMMARY

An embodiment of the invention provides an input lock/unlock method for a hand-held device triggered by a touch panel. By implementing the lock/unlock mechanism, the hardware and software resource corresponding to the man-machine interface (MMI) can be used in a more flexible and efficient manner.

An embodiment of the touch panel lock/unlock method disclosed in the invention comprises retrieving a pattern sensed by a touch panel of a hand-held device, then determining if the retrieved pattern matches a specific pattern, checking a status of the touch panel and issuing a relative command according to the status if the retrieved pattern matches the specific pattern, and finally executing a lock/unlock function according to the relative command. The issued relative command is “unlock” if the status of the touch panel is locked, and “lock” if the status of the touch panel is unlocked. The lock/unlock function is executed to enable or disable the hand-held device to accept input from the touch panel, and in another embodiment, the lock/unlock function can also enable or disable the hand-held device to accept input from a keypad of the hand-held device.

In an embodiment, the specific pattern is a closed zone, thus the lock/unlock function is only triggered if the retrieved pattern is a closed zone. The method of recognizing the retrieved pattern for triggering the lock/unlock function includes examining if any pixel on the touch panel has been touched at least twice. The pattern sensed by the touch panel is recorded as a data entry comprising coordinates corresponding to sequential touched pixels. The data entry starts recording the coordinates once a pen touches the touch panel, and stops recording immediately after the pen leaves the touch panel. The pattern is determined to be a closed zone if there are at least two identical coordinates in the entered data entry.

An embodiment implementing the touch panel lock/unlock method, a specific region on the touch panel is reserved and dedicated to sensing the pattern for triggering the lock/unlock function, and the specific region is the only region on the touch panel that will not be locked while the remaining touch panel is locked by the lock/unlock function. Another embodiment allows the lock/unlock function to be executed to lock the unlocked the touch panel only if the specific pattern is sensed on a nonworking region of the touch panel. Yet another embodiment allows the lock/unlock function to be executed to lock the unlocked touch panel only when the touch panel displays a predetermined frame, for example, when the screen shows the main menu.

### BRIEF DESCRIPTION OF THE DRAWINGS

The invention can be more fully understood by reading the subsequent detailed description in conjunction with the examples and references made to the accompanying drawings, wherein:

FIG. 1 is a simplified diagram illustrating a mobile phone with a touch panel.

FIG. 2a is a flow chart illustrating the lock/unlock method according to an embodiment of the invention.

FIG. 2b is a flow chart illustrating the lock/unlock method according to an embodiment of the invention.

FIG. 3 illustrates some examples of the closed zone pattern for triggering the lock/unlock function according to an embodiment of the invention.

FIG. 4 illustrates a closed zone recognition algorithm according to an embodiment of the invention.

FIG. 5 illustrates an exemplary mobile phone having a specific region for triggering the lock/unlock function according to an embodiment of the invention.

FIG. 6 shows the nonworking region on the touch panel of a mobile phone for the user to draw a closed zone pattern to lock the phone according an embodiment of the invention.

### DETAILED DESCRIPTION

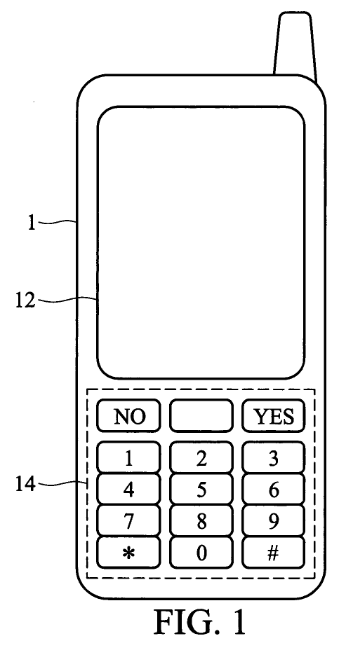

FIG. 1 shows a hand-held device 1 with a touch panel 12 and a keypad 14. The lock/unlock function is activated for toggling the lock/unlock state of the hand-held device 1 by first retrieving a specific pattern using the touch panel 12, and subsequently, the digital signal processor (DSP) recognizing the input pattern using a pattern recognition algorithm and issuing a command. The lock/unlock function is thus executed according to the command by the relative software and hardware. The lock/unlock function can lock either the touch panel 12 or the keypad 14, or both the touch panel 12 and the keypad 14, to prevent unwanted input from the touch panel 12 or the keypad 14.

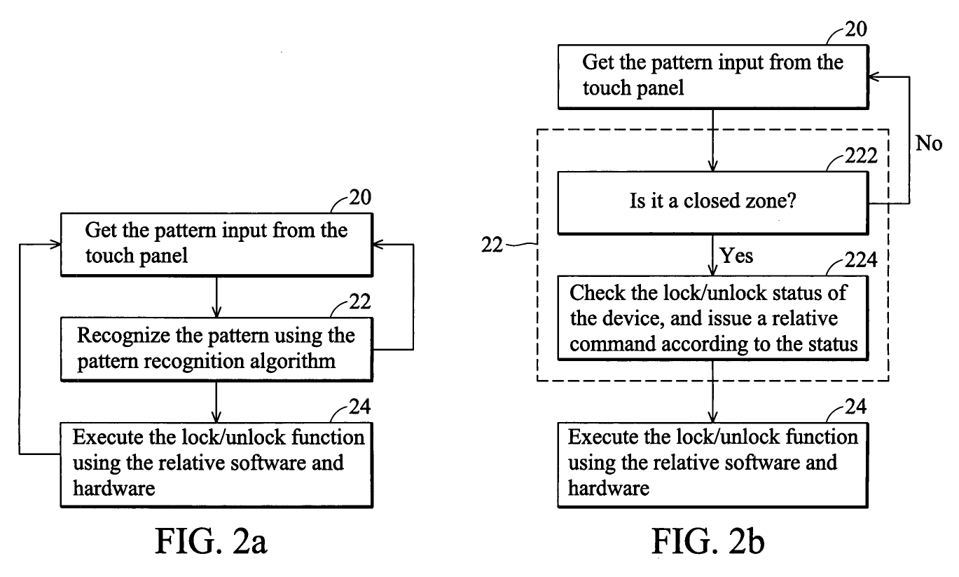

FIGS. 2a and 2b are flow charts of the touch panel lock/unlock method according to an embodiment of the invention. As shown in FIG. 2a, the hand-held device first retrieves a pattern from the touch panel in step 20. The pattern may be represented by a set of coordinates of the touched pixels sensed by the touch panel. The DSP of the hand-held device performs the pattern recognition algorithm to recognize and validate the input pattern for triggering the lock/unlock function (step 22). The DSP triggers the relative software and hardware to execute the lock/unlock function (step 24) if the pattern retrieved in step 20 is valid in step 22, and if invalid, it waits until a valid pattern input via the touch panel (return to step 20). In an embodiment, the validity of the retrieved pattern is judged by comparing the retrieved pattern to a specific pattern stored in a storage means, such as a memory device.

In order to simplify the pattern recognition algorithm and conserve the memory, in a preferred embodiment, the retrieved pattern is determined to be valid if it is a closed zone pattern. Accordingly, FIG. 2b further describes the preferred embodiment of step 22 shown in FIG. 2a, wherein the pattern recognition algorithm includes determining if the pattern obtained in step 20 is a closed zone (step 222), and if yes, checking the lock/unlock status of the hand-held device and issuing a relative command according to the status (step 224). The relative command is used to trigger the relative software and hardware to execute the lock/unlock function in step 24. If the pattern obtained from the touch panel is not a closed zone, the lock/unlock function will not be triggered, and will remain idle until another pattern is input via the touch panel. The relative command requests the software and hardware to execute the unlock function if the current status of the hand-held device is locked, whereas the relative command requests the software and hardware to execute the lock function if the current status is unlocked. The lock/unlock function can be configured to enable or disable the hand-held device from accepting input from either the touch panel or the keypad, or both.

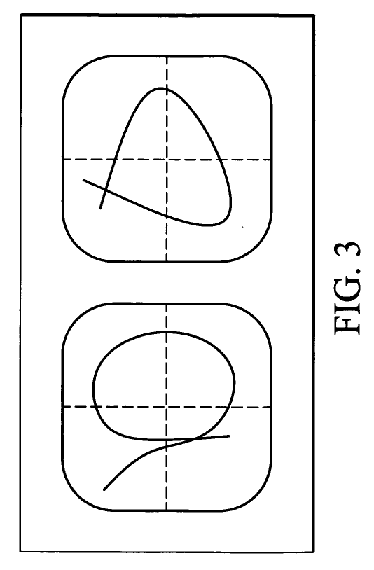

FIG. 3 illustrates two exemplary patterns which will be recognized by the DSP of the hand-held device as closed areas. Note that the pattern must be a continuous drawing, meaning that it must be drawn with a single unbroken stroke.

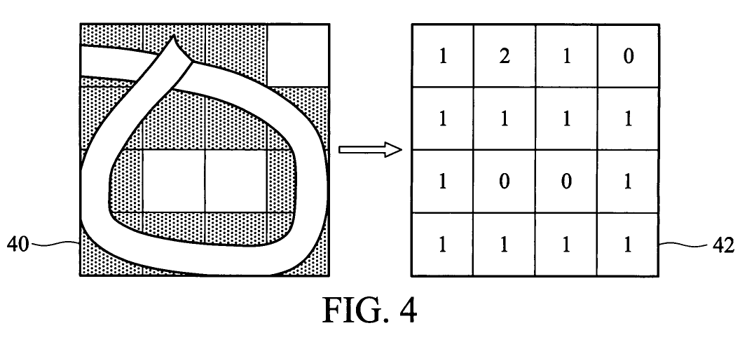

The man-machine interface (MMI) function recognition algorithm executed by the DSP determines if the input pattern is a closed zone by first recording all the coordinates of the touched pixels, determining if any two recorded coordinates are identical (denoting that the input pattern is a closed zone since at least one pixel is touched twice), and if there are at least two equal coordinates, the pattern is determined to be a closed zone. FIG. 4 illustrates the closed zone recognition algorithm according to the embodiment of the invention. As shown in FIG. 4, the touch panel 40 having 4*4 (16) pixels is touched by a stylus, where the shaded pixels denote the pixels touched by the stylus. The corresponding matrix 42 shows the number of times touched by the stylus for each pixel of the touch panel 40. The DSP purposely searches for any repeatedly touched pixel, in other words, touched by the stylus at least twice. As shown in FIG. 4, the element in the second column first row of the corresponding matrix 42 shows a “2”, denoting the corresponding pixel has been touched twice, thus the DSP determines the input pattern is a closed zone.

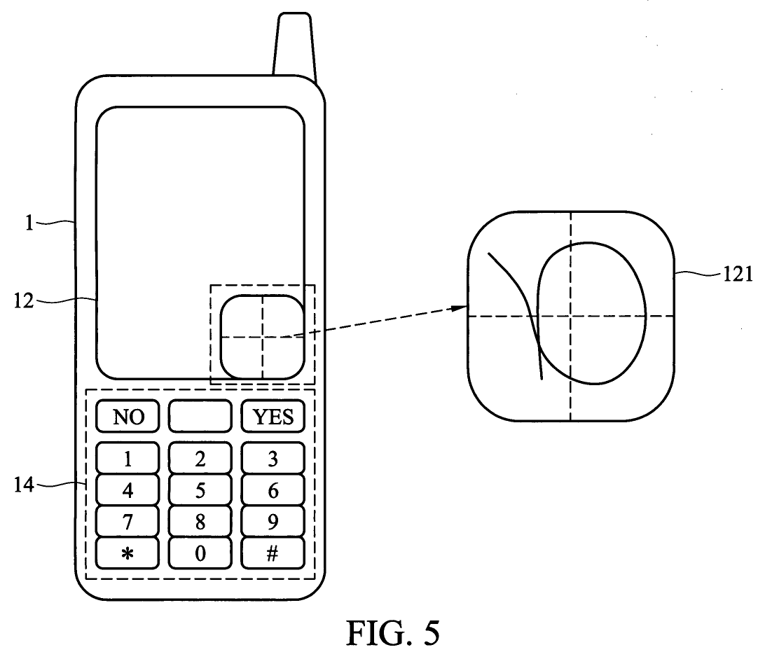

In an embodiment of the invention, there is a specific region on the touch panel is dedicated for triggering the lock/unlock function. As shown in FIG. 5, a mobile phone 1 comprises a touch panel 12 and a keypad 14, and a specific region 121 on the touch panel 12 is reserved for locking or unlocking the touch panel 12 and/or the keypad 14. For example, if a user draws a closed circle on the specific region 121 when the mobile phone 1 is unlocked, according to the provided lock/unlock method of the invention, a locking command is sent to the relative software and hardware to execute the lock function. As a result, the mobile phone 1 disables the keypad 14 and the touch panel 12 with the exception of the specific region 121 to receive any input. The specific region 121 thus becomes the only input means for activating, which triggers the relative hardware and software to execute the unlock function when detecting another closed zone pattern drawn on the specific region 121. In this embodiment, the remaining touch panel does not transform a “closed zone” pattern into a lock/unlock command, thus avoiding unintentionally triggering a lock/unlock function while inputting data for other applications. This embodiment, however, wastes a portion of the usable area of the touch panel since the region 121 can only be used to trigger the lock/unlock function and cannot be used to execute other functions.

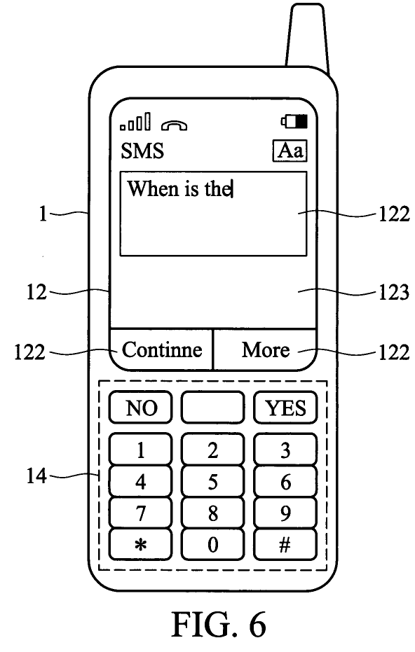

Another embodiment is provided to ameliorate the previously described drawback. Instead of limiting the user to drawing a closed zone pattern on a dedicated region for activating the lock/unlock function, the user is allowed to draw anywhere outside the current working area to trigger the lock/unlock function. FIG. 6 illustrates an exemplary mobile phone with a touch panel 12, and the touch panel 12 can be divided into working regions 122 and nonworking region 123. For the purpose of locking, the user can draw a closed zone pattern within the nonworking region 123, and consequently the DSP of the mobile phone 1 activates the locking function for disabling the touch panel 12 and the keypad 14 until a closed zone pattern is again detected by the touch panel 12.

In another embodiment, the lock/unlock function is triggered by drawing a closed zone pattern when the screen displays a predetermined frame, for example, when the touch panel displays the main menu.

The advantages of implementing a lock/unlock function on the touch panel according to embodiments of the invention include, utilizing the hardware resource and the touch panel in a more efficient manner, and providing flexibility to designers and manufacturers of the hand-held devices for MMI function implementation.

While the invention has been described by way of examples and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A touch panel lock/unlock method for a hand-held device, comprising:
retrieving a pattern sensed by a touch panel of the hand-held device;
determining if the retrieved pattern matches a specific pattern;
checking a status of the touch panel and issuing a relative command according to the status if the retrieved pattern matches the specific pattern; and
executing a lock/unlock function according to the relative command.

2. The touch panel lock/unlock method according to claim 1, wherein the specific pattern is a closed zone.

3. The touch panel lock/unlock method according to claim 2, wherein the pattern is determined to be a closed zone if there is at least one pixel on the touch panel has been touched more than once.

4. The touch panel lock/unlock method according to claim 2, wherein the pattern sensed by the touch panel that is recorded as a data entry comprising coordinates corresponding to sequentially touched pixels.

5. The touch panel lock/unlock method according to claim 4, wherein the data entry begin recording the coordinates once a stylus touches the touch panel and ends recording immediately after the stylus leaves the touch panel.

6. The touch panel lock/unlock method according to claim 4, wherein the pattern is determined to be a closed zone if there are at least two identical coordinates in the data entry.

7. The touch panel lock/unlock method according to claim 1, wherein the relative command is “unlock” if the status of the touch panel is locked, and the relative command is “lock” if the status of the touch panel is unlocked.

8. The touch panel lock/unlock method according to claim 1, wherein the lock/unlock function is executed to enable or disable at least a portion of the touch panel.

9. The touch panel lock/unlock method according to claim 8, wherein the hand-held device further comprises a keypad, and the lock/unlock function is executed to enable or disable at least some keys on the keypad.

10. The touch panel lock/unlock method according to claim 8, wherein a specific region of the touch panel is reserved and dedicated to sensing the pattern for locking/unlocking the touch panel, and the specific region is the only region of the touch panel which is not locked while the touch panel is locked by the lock/unlock function.

11. The touch panel lock/unlock method according to claim 8, wherein the lock/unlock function is executed to lock the unlocked touch panel only if the retrieved pattern that matches the specific pattern is sensed on a nonworking region of the touch panel.

12. The touch panel lock/unlock method according to claim 8, wherein the lock/unlock function is executed to lock the unlocked touch panel if the retrieved pattern that matches the specific pattern is sensed when the touch panel displays a predetermined frame.

13. The touch panel lock/unlock method according to claim 12, wherein the predetermined frame is shown when returning to a main menu.
